(19) United States
(12) Patent Application Publication
(10) Pub. No.: US 2005/0158431 A1
(43) Pub. Date: Jul. 21, 2005

(54) Stabilization of cochineal dye in aqueous solutions

(75) Inventors: Ken Knoblock, Terre Haute, IN (US); Kathleen Laurenzo, Terre Haute, IN (US); Charles Nichols, Terre Haute, IN (US)

Correspondence Address: SCULLY SCOTT MURPHY & PRESSER, PC, 400 GARDEN CITY PLAZA, SUITE 300, GARDEN CITY, NY, 11530, US

(73) Assignee: DANISCO A/S, COPENHAGEN K (DK)

(21) Appl. No.: 10/761,851

(22) Filed: Jan. 21, 2004

(51) Int. Cl. A23L 1/27

(52) U.S. Cl. 426/250

(57) ABSTRACT

The invention relates to a method for the stabilization of cochineal dye in aqueous solutions, such as beverages, and to aqueous solutions of cochineal, which are stabilized against the photo-induced fading of the cochineal dye. The invention also relates to a composition useful in the stabilization of cochineal solutions against fading. The stabilization of the cochineal is provided by an effective stabilizing amount of a transition metal, such as copper, iron or zinc in the solution.

### BACKGROUND OF THE INVENTION

This invention relates to a method for the stabilization of cochineal dye in aqueous solutions, such as beverages, and to aqueous solutions of cochineal which are stabilized against the photo-induced fading of the cochineal dye. The invention also relates to a composition useful in the stabilization of cochineal solutions against fading.

Cochineal is a natural food colorant derived from certain insects such as a tropical American insect that feeds on certain species of cactus. The use of cochineal in food and drugs is allowed in the U.S. according to 21 CFR 73.100. The active pigment in cochineal is carminic acid, which has an anthraquinone nucleus and which is well known to fade over time in contact with light. Cochineal is used in the food industry and especially in the beverage industry as a dye for various kinds of beverages. The photo-induced fading of the dye causes problems during prolonged storage of the products in the presence of light.

A number of attempts have been made to increase the photostability of cochineal in aqueous solutions. For example, JP 2001275611 claims the use of rosmarinic acid to stabilize cochineal. JP 02031660 discloses that flavonoids, e.g., rutin, stabilize cochineal. In U.S. Pat. No. 4,613,672, tea catechins are found to stabilize the color of cochineal. All the mentioned substances are antioxidants. It was thought that antioxidants would protect the carminic acid from oxidation and color fading.

U.S. Pat. No. 6,630,186 B1 discloses adding nigerooligosaccharides as anti-fading agents to cochineal pigment containing beverages. The beverages may contain vitamin C, dietary fibers, sweeteners, flavoring agents and other conventional components. Vitamin C and dietary fibers promote the fading of the cochineal pigment, whereas nigerooligosaccharides were found to reduce the photo-induced fading of the dye in a concentration related manner.

GB 2190822 discusses the photo-induced fading of another natural coloring agent, crocin, which is a carotenoid coloring agent. According to the publication the color is stabilized by removal of transitional metal ions to less than 5 ppm in an aqueous medium containing ascorbic acid. The metal ions are thought to catalyze reactions, which are harmful to the carotenoid color. The patent also includes an example, which in addition to the crocin includes cochineal as a colorant. However, there is no indication of any effect of the transition metals on the cochineal in the document.

It should be noted that all documents cited in this text (“herein cited documents”) as well as each document or reference cited in each of the herein-cited documents, and all manufacturer's literature, specifications, instructions, product data sheets, material data sheets, and the like, as to the product mentioned in this text, are hereby expressly incorporated herein by reference.

### SUMMARY OF THE INVENTION

The present inventors have, unexpectedly, found that the deliberate presence of very small amounts of certain transition metals actually contributes markedly to the color stability of cochineal. It was found that the color stability of cochineal solutions varied dramatically with the level of transition metals in the water used to make the aqueous solutions. Surprisingly, the color stability was at its worst in the very purest water, and highest in well water containing small amounts of transition metal ions. Experiments showed that the most effective cations are copper (II), iron (III) and zinc (II) in the order of effectiveness Cu>Fe>Zn.

Accordingly, the present invention provides a method for the stabilization of the color of cochineal dye in an aqueous solution, which method comprises providing in a cochineal colored aqueous solution an effective stabilizing amount of a transition metal capable of slowing down the photo-induced fading of said cochineal dye.

The solution preferably comprises a cochineal colored beverage having an acidic pH of 5 or below and preferably pH 2.5 to 3.5. The solution may contain citric acid, lactic acid, ascorbic acid (vitamin C) or other conventional acids used in the art. The preferred beverages include ascorbic acid either as an added chemical or as a part of naturally occurring ingredients such as fruit juices.

The solution preferably contains a water-soluble dietary fiber. It is known that dietary fibers enhance the color fading property of cochineal and hence increase the photo-instability of cochineal. Preferred dietary fibers in beverages are water-soluble natural or synthetic carbohydrate polymers such as polydextrose, inulin, or pyroconverted starch. The most preferred fiber is polydextrose, especially purified or hydrogenated polydextrose.

Most beverages also contain ascorbic acid (vitamin C), which likewise affects the fading of the cochineal dye. The more dietary fiber and/or ascorbic acid the solution contains, the greater is the need for including transition metal cations into the solution. Beverages typically contain from 1 to 20 g dietary fiber and from 10 mg to 1 g ascorbic acid per 100 ml of the beverage.

The present invention also provides an aqueous solution containing cochineal as a dye and a transition metal as a color stabilizer. The transition metal stabilizer should be included in an effective stabilizing amount capable of significantly slowing down the photo-induced fading of the cochineal dye in the solution. A transition metal level of 10 ppm (i.e. 10 μg transition metal per ml of solution) has proven effective in all situations. In practice significantly lower levels are generally sufficient.

The aqueous solution of the invention is preferably a beverage but it is obvious that the solution may also be used in other food applications where the color fading of cochineal poses a problem. The transition metal(s) may be added directly to the solution but clear benefits are obtained by including the metals in a dietary fiber composition. The invention thus also provides an anti-fading composition for a cochineal solution comprising water-soluble dietary fiber useful for fiber beverages and an effective stabilizing amount of a transition metal.

### DETAILED DESCRIPTION OF THE INVENTION

In aqueous solutions, cochineal gradually loses color over time. This decolorization is enhanced by light. When exposed to light, solutions which contain dietary fibers and solutions from which transition metals have been rigorously removed show accelerated dye decolorization. For the purposes of the invention, the light stability of colorants in aqueous solution may be described in terms of their color loss or color retention in a given period of time.

In accordance with the invention the decolorization of the cochineal solutions is prevented or reduced by the active use of transition metal ions in the solution. The amount of transition metal should be sufficient so as to exert a stabilizing effect on the cochineal. The effect of the transition metals has been found to be concentration dependent and consequently, the amount to be used in any specific solution depends i.a. on the length of time that the solution is to be stored in the presence of light.

Potable well water—with a mineral content higher than that found in deionized water—may be added to deionized water such that the light stability of the colorant is increased in proportion to the amount of potable well water in the diluent. However, in order to exert better control over light stability, the transition metal salts should be added directly to the cochineal solution prior to exposure to light.

Salts of copper, iron and zinc may be added to separate colorant solutions made with water having a low level of metals such as deionized water so that the combined cation concentration is about 10 ppm (w/v). In this way the rate of color loss is decreased. In many situations it is preferred to add only one kind of transition metal, such as copper or iron to the solution.

It has been found that the specific ion species, copper (II), iron (III) and zinc (II) are the most effective ones to use in the context of the invention. The effective amount of transition metal to be used when making a beverage in accordance with the present invention is from 0.01 to 15 ppm calculated as the weight of the metal ion on the volume of the aqueous beverage. For copper (II) the preferred effective range is between 0.02 and 5 ppm, most preferably from 0.03 to 0.1 ppm.

Certain beverages contain dietary fibers which are considered to make the beverage healthier for the consumer. Such dietary fibers are typically water-soluble carbohydrate polymers and they are preferably based on polydextrose, inulin and/or starch derived dextrinous products. These dietary fibers typically comprise oligo- or polysaccharides but they are distinct from the nigerooligosaccharides used in U.S. Pat. No. 6,630,186 as anti-fading agents. The dietary fibers have been found to have an effect contrary to the nigerooligosaccharides in that they activate the fading of cochineal. Said nigerooligosaaccharides are mainly composed of glucose units attached by α-(1,3) bonds. Preferred nigeroologosaccharides according to said patent are nigerose, nigerosylglucose, nigerosylmaltose and the like.

The term “polydextrose” as used herein refers to a low calorie polymer of glucose that is substantially resistant to digestion by the enzymes in the stomach. It includes polymer products of glucose which are prepared from glucose, maltose, oligomers of glucose or hydrolyzates of starch, which are polymerized by heat treatment in a polycondensation reaction in the presence of an acid e.g. Lewis acid, inorganic or organic acid, including monocarboxylic acid, dicarboxylic acid and polycarboxylic acid.

The term polydextrose also includes those polymer products of glucose prepared by the polycondensation of glucose, maltose, oligomers of glucose or starch hydrolyzates described hereinabove in the presence of a sugar alcohol, e.g. polyol. Moreover, the term polydextrose includes the glucose polymers, which have been purified by techniques described in the art, and hydrogenated polydextrose, which, includes hydrogenated or reduced polyglucose products prepared by techniques known to one of ordinary skill in the art. The term polydextrose also encompasses fractionated polydextrose which is a conventional, known material. In a preferred embodiment of the invention the polydextrose is purified polydextrose. In another preferred embodiment, the polydextrose used is hydrogenated or reduced polydextrose.

Polydextrose may, for instance, be purified by ion exchange and then reduced (U.S. Pat. No. 5,601,863). In a preferred embodiment of the invention low levels of copper are used in such altered polydextrose forms to improve cochineal color retention.

Polydextrose is commercially available from companies such as Danisco Sweeteners, Staley and Shing Dong Bang. Purified forms of polydextrose are marketed by Danisco Sweeteners under the name Litesse® or Litesse® II. A reduced form of Litesse® is called Litesse® Ultra. The specifications of the Litesse® polydextrose products are available from Danisco Sweeteners.

The term “inulin” as used herein refers to a polydisperse GFₙ molecule (G=glucose, F=fructose, n=an integer). It is built as a linear chain of fructose units by means of β-(2, 1) bonds, having one terminal glucose molecule. Essentially, inulin is sucrose attached to a chain of fructose molecules of varying length. It is a naturally occurring carbohydrate, extracted from chicory roots by a physical process similar to that used in extracting sugar from sugar beets. A commercially available native chicory inulin product useful in beverages is e.g. Raftiline® available from Orafti. Raftiline® typically has a DP range of 1 to as high as 60.

A further dietary fiber useful in beverages is partially hydrolyzed inulin produced from inulin by an enzymatic hydrolysis that breaks the Fₙ chain somewhere in the middle, converting the GFₙ molecule to a mixture of GFₙ (where n is smaller than before) and Fₙ molecules. For example, GF₁₀ might be converted to GF₅ and F₅. A commercially available partially hydrolysed inulin product useful in beverages is e.g. Raftilose® available from Orafti. Raftilose® typically has a DP range of 1-7.

Both Raftiline® and Raftilose® can contain varying amounts of glucose, fructose and sucrose.

A further water-soluble dietary fiber is derived by pyroconversion from starch. Starch is made of glucose molecules attached by α-(1,4) bonds, with some branching by means of α-(1,6) bonds. The degree of branching depends on the source of the starch. A useful dietary fiber is made from corn starch with only a moderate degree of branching. Starch itself is digestible and water-insoluble.

The dietary fiber is produced from starch in a heat treatment process known as pyroconversion. Pyrodextrins are starch hydrolysis products obtained in a dry roasting process either using starch alone or with trace levels of acid catalyst. The first product formed in this reaction is soluble starch, which in turn hydrolyzes further to form dextrins. The molecular weight of the final product depends on the temperature and duration of heating. Transglucosidation can occur in the dextrinization process, in which rupture of an α-(1,4) glucosidic bond is immediately followed by combination of the resultant fragments with neighboring hydroxyl groups to produce new linkages and branched structures. Thus, a portion of the glycosidic bonds is scrambled.

The dextrin thus formed is water-soluble, and composed of digestible and indigestible fractions. To increase the indigestible fraction, the dextrin is treated with alpha-amylase. Alpha-amylase is an endo-amylase that randomly hydrolyzes α-(1,4) glycosidic linkages in amylose and amylopectin. The breakdown products are oligosaccharides and dextrins of varying chain length. This also increases solubility and reduces viscosity. Then, glucoamylase is added. Glucoamylase is an exo-type enzyme that hydrolyzes α-(1,4) glycosidic linkages in the digestible fractions of the dextrin to glucose, which then may be removed to leave a dextrin fraction indigestible by human alimentary enzymes and is water-soluble. A commercially available pyroconverted starch is called Fibersol-2® and is available from Matsutani America, Inc.

The amount of water-soluble dietary fiber that is added to a beverage may vary according to the formulation in question. Beverages typically contain from 1 to 20% dietary fiber calculated as the weight of the fiber on the volume of the beverage. Polydextrose is typically added in an amount of 5 to 10% although it is soluble up to 30% or more. Increasing the level of dietary fiber seems to quicken the degradation of the color of the cochineal.

According to a preferred embodiment of the invention, the increase in color loss caused by the dietary fibers in a cochineal containing solution is countered by adding transition metals to said solution. The transition metals are preferably added as cations (preferably at a nominal level in the order of 10 ppm) to acidic dye solutions containing a carbohydrate dietary fiber, such as polydextrose (preferably at a level of about 5 to 10% w/v).

Copper and iron impart greater light stability than zinc and a have a very well behaved interaction in the dye/acid/fiber systems across a wide concentration range.

The transition metals may be added directly to the cochineal containing solution such as an acidic dye solution as salts. Said salts should be acceptable for use in consumable products such as beverages both from the point of view of toxicity and taste. Preferred salts are chloride and sulfate salts which are well soluble in water. The transition metals may be added to the aqueous vehicle forming the cochineal solution or beverage either after the cochineal has been added or prior to the addition of the cochineal. In one embodiment of the invention, the transition metals are included as part of the aqueous vehicle used for producing the cochineal solution or beverage. In a preferred embodiment, the transition metals are provided by adding salts of one or more of the transition metals directly to an acidified cochineal solution.

The metal ions are preferably included in the solution or beverage in an amount of 0.01 to 15 ppm calculated as the weight of the metal ion on the volume of the aqueous solution. When the transition metal is Cu (II), it is preferably included at a level of 0.02 to 5 ppm, more preferably at a level of 0.03 to 0.1 ppm.

The transition metals may also be added as metals dissolved and/or solvated by a suitable organic or inorganic acid, such as citric or phosphoric acid. For example, copper metal can be partially dissolved in citric or phosphoric acid under relatively mild conditions and in a form which imparts color stability. A low level of copper addition in this manner has been found to have a good effect on the color retention.

In cochineal solutions containing dietary fiber, copper may be added at levels as low as 0.1 μg copper and as high as 150 μg or more copper as Cu (II) per gram of fiber with distinct improvement in color retention of dye/ascorbic acid/fiber solutions. The amount of copper is preferably 0.2 to 2 μg per gram of fiber polymer. Similarly, iron may be added as Fe (III) at levels between 0.2 μg and 150 μg iron per gram of dietary fiber with clear improvement in color retention of dye/ascorbic acid/fiber solutions. The amount of iron is preferably 0.3 to 2 μg per gram of fiber.

However, when adding transition metals to the dye solution, it is most convenient to add them as part of the dietary fiber matrix. In this case, transition metals may be added to the carbohydrate polymer fiber during the production or recovery thereof. A suitable cation may be added, for instance, in the polydextrose synthetic reaction vessel or after the initial synthesis to the production process stream. Thus, the invention provides in one aspect thereof an anti-fading composition for a cochineal solution said composition comprising water-soluble dietary fiber useful for fiber beverages and an effective stabilizing amount of a transition metal capable of significantly slowing down the photo-induced fading of cochineal dye in said aqueous solution. The transition metal(s) may be included in the dietary fiber during the synthesis and/or finishing thereof.

When added to the dietary fiber raw materials the transition metals may take the form of salts or solvated dissolved metals. When added to the liquid process stream they may take the form of a salt or solvated dissolved solid that is added before the liquid stream is evaporated to dryness.

When the cochineal solution is made into a consumable product, such as a beverage, it is mixed with conventional ingredients used in the production of such products. In the case of cochineal colored beverages, the beverage typically contains from 1 to 200 ppm, preferably 10 to 50 ppm cochineal dye calculated as the weight of the cochineal extract on the volume of the beverage. The amount of cochineal extract depends on the potency of the extract and therefore the amount of cochineal used may vary within a wide range. In fiber enforced beverages the dietary fiber content is typically between 1 and 20% and the amount of transition metals is typically from 0.1 to 150 μg per g calculated on the weight of the dietary fiber. In a fiber drink containing polydextrose as the dietary fiber and copper as the transition metal, the amount of polydextrose is most preferably 3 to 10% (w/v) and the amount of Cu (II) which is effective in stabilizing the cochineal color is preferably from 0.2 to 2 μg per g calculated on the weight of the polydextrose.

The method for measuring color loss (or retention) in cochineal is as follows. Ascorbic acid and colorant are added to water at a rate of 5.7 μl and 42 mg/l, respectively. The solution is acidic with pH about 2.5-3.5 and has an absorption maximum around 495 nm. In certain instances a carbohydrate fiber such as polydextrose (80 mg dry solids per ml, unless otherwise noted) is added to the solution. All water for the assay should be obtained from a common vessel. Exactly 100 ml of the dye solution is transferred to a 4 oz. (113 g) clear glass bottle measuring 1.5″ (3.8 cm) in diameter and 5.5″ in (14 cm) height. The bottles are capped and transferred to an incubator capable of delivering 12,000-15,000 Lux of cool-white fluorescent light and maintaining a temperature of 25° C. Light exposure is maintained for at least 14 days (unless otherwise noted). Uniformity of light exposure among bottles is critical. Samples are repositioned in the incubator as necessary to ensure even distribution of light among bottles. Periodically a small portion (˜5 ml) of the sample is removed and the optical density (OD) is measured through a 1 cm glass cuvette at 495 nm. The color retained by the dye solution (% CR) following exposure to light for “n” days is calculated as follows:
OD_{DAY n}×100/OD_{DAY 0}

The following examples illustrate the invention. For all the examples below, the method for evaluating color loss (or retention) of the dye followed that in the detailed description above, unless otherwise noted.

### EXAMPLE 1

The dependence of cochineal dye color retention on water purity was shown as follows. Dye solution was prepared by adding 4.2 mg of cochineal dye (obtained from Otsuka Pharmaceutical Co., Ltd.), and 0.57 g of ascorbic acid and 0.1 g of citric acid adjusted to pH 2.8 to 100 ml water from two sources (plant well or plant deionized) mixed in the ratios indicated in Table 1. Well water was passed through a 0.45 micron membrane type filter to remove suspended solids prior to use. Polydextrose in the form of Litesse® from Danisco Sweeteners (8% w/v) was present in all solutions. Color retentions were measured after 14 days of exposure to light (Table 1). The correlation coefficient (r²) for the linear regression of the scatter plot of % well water versus % CR was 0.990. Well water differs from deionized (DI) water in its mineral content, especially Cu, Fe and Zn. A typical elemental analysis for each water type is in Table 2.

TABLE 1
Color retention (% CR) in solutions of various
admixtures of well and deionized water

| % of well water in | % CR on Day |
|---|---|
| well/DI mixture | 14 |
| 100 | 30.8 |
| 50 | 26.9 |
| 10 | 22.6 |
| 0 | 21.2 |

TABLE 2
Selected elemental content in ppm (weight per volume of water)

| | Well | Deionized | | Well | Deionized |
|---|---|---|---|---|---|
| Element | Water | Water | Element | Water | Water |
| Al | <0.20 | <0.20 | Mn | 0.05 | 0.02 |
| Ba | 0.05 | <0.05 | Mo | <0.10 | <0.10 |
| Ca | 118 | <1.00 | P | <1.00 | <1.00 |
| Cr | <0.10 | <0.10 | K | <5.00 | <5.00 |
| Cu | 0.03 | <0.03 | Na | 41.7 | <5.00 |
| Fe | 0.47 | <0.10 | Sr | 0.19 | <0.01 |
| Mg | 35.8 | <1.00 | Zn | 1.41 | 0.17 |

For comparison it may be noted that the kind of highly purified water used in the subsequent Examples typically has mean values in the order of 0.003 ppm Cu, 0.06 ppm Fe and 0.02 ppm Zn.

### EXAMPLE 2

The gross effect of certain cations to improve color retention was shown as follows. As in Example 1 the dye and ascorbic acid/citric acid were dissolved in water purified by a purification system based on ion-exchange (Milli-Q Ultra-pure Water System available from Millipore). Reagent grade cupric chloride dihydrate, zinc(II) chloride or ammonium ferric sulfate dodecahydrate were added to the dye solution such that exogenous cation concentrations of 8, 10, and 10 ppm (w/v), respectively, were achieved. Polydextrose in the form of Litesse® was also added (8% w/v) to one set of solutions. Color retentions were measured after 14 days of exposure to light. The addition of these cations improved the color retentions as noted in Table 3. The relative ability of the selected cations to improve light stability was: Cu>Fe>Zn.

TABLE 3

% CR on Day 14 for the indicated Cation

| Sample | None | Fe(III) | Cu(II) | Zn(II) |
|---|---|---|---|---|
| Diluent Only | 64 | 86 | 92 | 77 |
| Litesse ® | 24 | 60 | 85 | 43 |

### EXAMPLE 3

The beneficial effect of low levels of copper on cochineal color retention was shown as follows. The dye and acids (amounts as in Example 1) were dissolved in water purified by a Milli-Q Ultra-pure Water System. Reagent grade cupric chloride dihydrate or cupric sulfate pentahydrate were added to two separate the dye solutions resulting in the exogenous Cu(II) concentrations indicated in Tables 4 and 5. To evaluate the chloride salt three lots of polydextrose in the form of Litesse® were added to the dye/copper solution at a polydextrose level of about 8% w/v; a single lot was used with the sulfate salt. Color retentions were measured after 14 days of exposure to light.

Copper improved the color retentions as noted in Tables 4 and 5. The relationship between copper and color retention is nearly linear at copper doses below 0.5 ppm. The correlation coefficients (r²) for the linear regression of the scatter plots of [Cu] versus % CR were 0.958 and 0.997 for the chloride and sulfate salts, respectively.

TABLE 4
Copper(II) chloride dihydrate, [Cu] is
noted as μg/g of polydextose

% CR on Day 14

| | Lot # | Lot # | Lot # | Mean of |
|---|---|---|---|---|
| [Cu] | V0115 | V0910 | V0914 | the three |
| μg/g | 0I | 0I | 0I | lots |
| 4.0 | 77 | 76 | 75 | 76 |
| 0.4 | 70 | 66 | 56 | 64 |
| 0.04 | 31 | 31 | 32 | 31 |
| 0 | 34 | 26 | 30 | 30 |

TABLE 5
Copper(II) sulfate pentahydrate, [Cu] is
noted as μg/g polydextrose

| [Cu] μg/g | % CR on Day 14 |
|---|---|
| 0 | 36 |
| 0.1 | 39 |
| 0.2 | 55 |
| 0.4 | 70 |
| 0.8 | 73 |

### EXAMPLE 4

The beneficial effect of low levels of iron on cochineal color retention was shown as follows. The dye and acids (amounts as in Example 1) were dissolved in water purified by a Milli-Q Ultra-pure Water System. Reagent grade ammonium iron(III) sulfate dodecahydrate was added to the dye solution resulting in the exogenous iron(III) concentrations indicated in Table 6. Polydextrose in the form of Litesse® was also added to the dye solution. Color retentions were measured after 14 days of exposure to light. Iron improved the color retentions as noted in Table 6.

TABLE 6
Ammonium ferric sulfate; [Fe] is noted as μg/g polydextrose

| [Fe] μg/g | % CR on Day 14 |
|---|---|
| 0 | 37 |
| 0.1 | 36 |
| 0.3 | 49 |
| 1 | 59 |

### EXAMPLE 5

Copper metal was partially dissolved in citric and phosphoric acid, respectively. Copper metal foil with an exposed surface area of 13 cm² was held with constant agitation in 250 ml of a 50% w/w solution of either citric or phosphoric acid for three days at 55° C. After another three weeks at room temperature the copper was removed. This imparted copper levels to the citric and phosphoric acid solutions of 245 and 600 μg/ml, respectively (as tested by inductively coupled plasma emission spectroscopy). To evaluate light stability, dye and ascorbic acid and citric acid (as in Example 1) were dissolved in water purified by a Milli-Q Ultra-pure Water System. Polydextrose in the form of Litesse® was also added (8% w/v). The copper-laced acid solutions were added to the polydextrose-containing dye solution resulting in exogenous acid and copper levels indicated in Table 7. Color retentions were measured after 14 days of exposure to light. Copper improved the color retentions as noted in Table 7.

TABLE 7
Effect of copper calculated as ppm by
weight on the volume of the solution

| Type and | | | | |
|---|---|---|---|---|
| concentration | [Cu] | % Cu-acid | | |
| of the acid | analysis of | (anhydrous | exogenous | |
| solution | each Cu- | basis) added | [Cu] ppm in | |
| used to | acid | to dye/ | dye/ | |
| dissolve | solution | polydextrose | polydextrose | % CR on Day |
| copper foil | (ppm) | solution | solution | 14 |
| 50% citric | 245 | 0.008 | 0.04 | 67 |
| acid | | 0.016 | 0.08 | 70 |
| 50% | 600 | 0.008 | 0.1 | 69 |
| phosphoric | | 0.016 | 0.2 | 72 |
| acid | | | | |
| none | Not | none | none | 39 |
| | applicable | | | |

### EXAMPLE 6

The ruggedness of copper activity during polydextrose synthesis was shown as follows. Polydextrose was synthesized with copper as a raw material. Dextrose and sorbitol were mixed in the ratio of 89:10 with copper chloride so that the mixture contained 1.3 ppm copper. These were heated in the presence of a catalytic amount of citric acid under reduced atmospheric pressure to form polydextrose (reactions 1 and 2). A second set of synthesis, without exogenous copper, was carried out with the same lot of raw materials (reactions 3 and 4). The material made this way met the FCC polydextrose identity test and had selected attributes listed in Table 8.

To evaluate light stability, dye and acids (as in Example 1) were dissolved in water purified by a Milli-Q Ultra-pure Water System. Polydextrose as prepared above, with and without exogenous copper, was also added. Color retentions were measured after 14 days of exposure to light. Copper added as a raw material improved color retentions in dye/polydextrose solutions as noted in Table 8. “APHA” in Table 8 refers to a standardized unit of solution color measurement used for lightly colored solutions.

TABLE 8
Effects of 0.1 ppm copper calculated
on the volume of the solution

| | | | % process | | |
|---|---|---|---|---|---|
| | | | related | APHA | % CR on |
| Reaction # | % polydextrose | % glucose | substances | color | Day 14 |
| 1 | 93.7 | 2.8 | 3.5 | <100 | 79 |
| 2 | 93.2 | 3.3 | 3.5 | <100 | 81 |
| 3 | 96.2 | 0.7 | 3.1 | 400 | 43 |
| 4 | 92.6 | 3 | 4.4 | <150 | 56 |

### EXAMPLE 7

A polydextrose solution to be added to a cochineal solution was resin treated during processing to reduce sourness resulting from residual catalyst acidity. The ruggedness of copper activity during resin purification was shown as follows.

Polydextrose was synthesized using a catalytic amount of citric acid that contained copper added by the method described in Example 5. Polydextrose solutions, which had acidity in the range of Type A polydextrose, were passed over a weak base anion exchange resin at a flow rate sufficient to reduce the acidity to about 0.01 to 0.02 milli-equivalents per gram polydextrose (as determined by titration with standardized NaOH).

To evaluate light stability, dye and ascorbic acid (as in Example 1) were dissolved in water purified by a Milli-Q Ultra-pure Water System. Polydextrose as prepared above was added in the ratio of 8 g per 100 ml beverage. Color retentions were measured after 14 days of exposure to light. Copper retained its ability to improve color retention in the dye solutions with no apparent reduction in activity due to polydextrose resin treatment (Table 9).

TABLE 9

| amount of copper (ppm) in | |
|---|---|
| beverage resulting from | |
| polydextrose addition | % CR on Day 14 |
| 0 | 65 |
| 0.06 | 72 |
| 0.13 | 74 |
| 0.42 | 79 |

### EXAMPLE 8

The water content of a polydextrose solution was reduced during processing from a range of 30-70% to ≦5%. The efficacy of copper after water removal was shown as follows.

A polydextrose (Litesse®) solution from a production process stream was collected on different days. The nominal water content was 40%. To a portion of this solution, copper(II) chloride dihydrate was added so that the copper content was 1.6 μg/g relative to the dissolved polydextrose solids. Water was removed from solutions containing copper, as well as those without exogenous copper, by the application of heat and reduced atmospheric pressure (Table 10).

To evaluate light stability, dye and ascorbic acid (as in Example 1) were dissolved in water purified by a Milli-Q Ultra-pure Water System. Polydextrose as prepared above was also added. Color retentions were measured after 14 days of exposure to light. Copper improved color retentions in the dye solutions relative to non spiked polydextrose (Table 10).

TABLE 10

| | | % water | |
|---|---|---|---|
| | exogenous | remaining after | % CR on Day |
| Sample # | copper | evaporation | 14 |
| S2E1 | no | 4.6 | 62 |
| S3E1 | no | 1.5 | 55 |
| S2E3 | yes | 3.1 | 78 |
| S3E4 | yes | 1.8 | 77 |

### EXAMPLE 9

Polydextrose was purified by ion exchange to produce a form in which the acidity was less than 0.03 milli-equivalents per gram polydextrose and then reduced such that the reducing saccharides was less than 1% of the total carbohydrate content. Reagent grade cupric sulfate pentahydrate, dye, ascorbic acid (as in Example 1) and the reduced polydextrose were dissolved in water purified by a Milli-Q Ultra-pure Water System. Color retentions were measured after 8 days of exposure to light. Copper improved the color retentions as noted in Table 11.

TABLE 11
% CR as a function of added copper (ppm on
a beverage basis) in reduced polydextrose

| Added [Cu] ppm | % CR on Day 8 |
|---|---|
| 0.6 | 81 |
| 0.06 | 80 |
| 0 | 76 |

### EXAMPLE 10

Reduced polydextrose prepared as in Example 9 in the ratios of 20, 8 and 3 gm/100 ml, reagent grade cupric sulfate pentahydrate, dye, and ascorbic acid/citric acid (as in Example 1) were dissolved in water purified by a Milli-Q Ultra-pure Water System. Color retentions were measured after 8 days of exposure to light. Copper improved the color retentions regardless of the concentration of polydextrose as noted in Table 12.

TABLE 12
% CR as a function of reduced polydextrose (rPDX) concentration
and added copper (ppm on a beverage basis).

% CR on Day 8

| | 0.06 ppm | NO added |
|---|---|---|
| % rPDX | added copper | copper |
| 20 | 79 | 67 |
| 8 | 80 | 76 |
| 3 | 81 | 74 |

### EXAMPLE 11

Polydextrose and other common polysaccharides used as dietary fibers were tested in a dietary fiber beverage. The polysaccharides tested were polydextrose (Litesse®), partially hydrolysed inulin (Raftilose® P95) and pyroconverted starch (Fibersol-2®). They were all found to have a color destabiliizing effect on the cochineal color in the beverage. Transition metal (copper) was used to reduce the decolorization. The assay procedure was the same as that of Example 1. The copper was added as the sulfate pentahydrate. The polysaccharide level was 8% w/v. Copper increased the light stability of the cochineal colored beverage as shown in Table 13.

TABLE 13
Effect of copper on light stability of a beverage made with Fibersol ® and
Raftilose ® (oligofructose). Data are color retention on day 14.

| | |
|---|---|
| Oligosaccharide | Cu added (ppm on a beverage basis) |

| Type | 0 | 0.04 | 0.4 | 10 |
|---|---|---|---|---|
| Fibersol-2 ® | 74 | 79 | 85 | 93 |
| Raftilose ® P 95 | 66 | 65 | 74 | 91 |
| Litesse ® | 71 | — | — | — |
| None, water only | 93 | — | — | — |

The invention has been illustrated above with examples showing the influence of transition metals on the light stability of aqueous cochineal solutions. The examples show amounts of transition metals and dietary fibers and ways in which such are added to the aqueous solution. The solutions of the examples are mixtures of cochineal dye, ascorbic acid/citric acid and dietary fiber. In practice the beverages and other products will additionally contain conventional ingredients such as sweeteners, juices, other vitamins and acids, minerals, flavors, etc. The influence of the transition metals has not been found to be materially affected by the other ingredients of the consumable products. Thus, the invention may be used in many ways known to those skilled in the art.

1. A method for the stabilization of the color of cochineal dye in an aqueous solution, comprising providing in a cochineal colored aqueous solution an effective stabilizing amount of a transition metal capable of slowing down the photo-induced fading of said cochineal dye.

2. The method according to claim 1, wherein said transition metal is a metal ion selected from the group consisting of copper, iron, zinc and combinations thereof.

3. The method according to claim 2, wherein said copper is Cu (II), said iron is Fe (III) and said zinc is Zn (II).

4. The method according to claim 1, wherein said aqueous solution contains a water soluble dietary fiber.

5. The method according to claim 4, wherein said dietary fiber is based on a carbohydrate polymer selected from polydextrose, inulin, or pyroconverted starch.

6. The method according to claim 5, wherein said dietary fiber comprises polydextrose.

7. The method according to claim 6, wherein said solution is a beverage and polydextrose is included in said beverage at a level of 1 to 20% calculated as the weight of the polydextrose on the volume of the aqueous beverage.

8. The method according to claim 7, wherein said polydextrose is included at a level of 3 to 10% calculated as the weight of the polydextrose on the volume of the aqueous beverage.

9. The method according to claim 1, wherein said solution has an acidic pH.

10. The method according to claim 9, wherein said solution is a beverage containing ascorbic acid and having a pH of 5 or less.

11. The method according to claim 2, wherein said metal ions are added to an aqueous vehicle forming the beverage.

12. The method according to claim 2, wherein said metal ions are included in an aqueous vehicle used for producing the beverage.

13. The method according to claim 7, wherein said metal ions are included in said beverage by adding salt(s) of said metal(s) directly to an aqueous acidified solution containing said cochineal.

14. The method according to claim 13, wherein said metal ions are included in said beverage in an amount of 0.01 to 15 ppm calculated as the weight of the metal ion on the volume of the aqueous beverage.

15. The method according to claim 14, wherein said metal ion is copper Cu (II) and it is included in said beverage in an amount of 0.02 to 5 ppm.

16. The method according to claim 15, wherein said copper Cu (II) is included in said beverage in an amount of 0.03 to 0.1 ppm.

17. The method according to claim 1, wherein said metal(s) is/are included in said solution as metal(s) dissolved or solvated by organic or inorganic acid(s).

18. The method according to claim 1, wherein said solution contains a soluble dietary fiber based on a carbohydrate polymer and said transition metal is added at a level of 0.1 to 150 μg per g of carbohydrate polymer.

19. The method according to claim 18, wherein said transition metal comprises copper Cu (II), which is added at a level of 0.2 to 2 μg per g of polymer.

20. The method according to claim 18, wherein said transition metal comprises iron Fe (III), which is added at a level of 0.3 to 2 μg per g of carbohydrate polymer.

21. The method according to claim 4, wherein said metal is added as part of the matrix of said dietary fiber.

22. The method according to claim 21, wherein said metal is included as a cation or a solvated dissolved metal in said carbohydrate polymer during the synthesis of said polymer or after the initial synthesis of said polymer.

23. The method according to claim 1 wherein said solution is an acidified beverage containing 1 to 200 ppm cochineal calculated by weight of cochineal extract on the volume of the beverage, 1 to 20% polydextrose calculated by weight on the volume of the beverage and 0.01 to 1% of ascorbic acid calculated on the volume of the beverage, and wherein said beverage is provided with about 0.2 to 2 μg/g Cu (II) calculated by weight on the weight of said polydextrose.

24. A solution colored with cochineal and comprising an aqueous solution containing cochineal as a dye and a transition metal in an effective stabilizing amount capable of significantly slowing down the photo-induced fading of said dye in said solution.

25. The solution according to claim 24, wherein said solution is an acidified cochineal colored beverage having an acidic pH between pH 2.5 and 5.

26. The solution according to claim 25, wherein said transition metal is a metal ion selected from the group consisting of copper Cu (II), iron Fe (III), zinc Zn (II) and combinations thereof.

27. The solution according to claim 25, wherein said aqueous solution contains a water-soluble dietary fiber.

28. The solution according to claim 27, wherein said dietary fiber is based on a carbohydrate polymer selected from polydextrose, inulin and pyroconverted starch.

29. The solution according to claim 28, wherein said dietary fiber comprises polydextrose.

30. The solution according to claim 29, wherein said polydextrose is included in said aqueous beverage at a level of 1 to 20% calculated as the weight of the polydextrose on the volume of the beverage.

31. The solution according to claim 26, wherein said metal ion(s) is/are included in said beverage in an amount of 0.01 to 15 ppm calculated as the weight of the metal ion(s) on the volume of the aqueous beverage.

32. The solution according to claim 24, wherein said solution comprises a beverage containing a soluble dietary fiber based on polydextrose and said transition metal is included at a level of 0.1 to 150 μg per g of polydextrose.

33. The solution according to claim 32 wherein said beverage is an acidified beverage containing 1 to 200 ppm cochineal, 1 to 20% polydextrose, 0.01 to 1% ascorbic acid and wherein said beverage contains as an effective amount 0.2 to 2 μg/g Cu (II) calculated by weight on the weight of said polydextrose.

34. An anti-fading composition for a cochineal solution comprising water-soluble dietary fiber useful for fiber beverages and an effective stabilizing amount of a transition metal capable of significantly slowing down the photo-induced fading of cochineal dye in an aqueous solution.

35. The anti-fading composition of claim 34, wherein said dietary fiber comprises polydextrose and said transition metal is a cation selected from Cu (II), Fe (III) and Zn (II) provided in an amount of 0.1 to 150 μg/g calculated by weight on the weight of the polydextrose.

36. The anti-fading composition of claim 35, wherein said transition metal has been included in said polydextrose during the synthesis and/or finishing thereof.
